(19) United States
(12) Patent Application Publication
(10) Pub. No.: US 2008/0076467 A1
(43) Pub. Date: Mar. 27, 2008

(54) Mobile communication apparatus

(75) Inventors: Wen-Chuan Lee, Taipei (TW); Yu-Hua Chang, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/902,739

(22) Filed: Sep. 25, 2007

(30) Foreign Application Priority Data
Sep. 27, 2006 (TW) 095135674

(51) Int. Cl. H04M 1/00

(52) U.S. Cl. 455/552.1

(57) ABSTRACT

The invention discloses a mobile communication apparatus selectively communicating with an access point (AP). The AP has a service area. At least one communication channel communicates with the AP and is used for transmitting signals. The mobile communication apparatus includes a first communication module and a second communication module. The first communication module transmits signals in a first communication protocol. When the mobile communication apparatus moves into the service area of the AP, the second communication module will communicate with the AP in a second communication protocol, such that the mobile communication apparatus is capable of selectively transmitting signals by the first communication module or transmitting signals by the second communication module via the at least one communication channel.

### BACKGROUND OF THE INVENTION

1. Field of the Invention

The invention relates to a mobile communication apparatus and, more particularly, to a mobile communication apparatus capable of selectively communicating via wireless network or Public Switched Telephone Network (PSTN).

2. Description of the Prior Art

In general, there is always a wired or wireless telephone set in one's home and connected with conventional PSTN for communication. When a user communicates with someone via PSTN, the calling rate is lower than other communication network. However, since the telephone has to communicate with PSTN by wire, the user cannot carry the telephone with him/her. It is inconvenient for the user.

On the other hand, most of the users nowadays always have at least one mobile phone. Since mobile phone can be carried at any time, it is more convenient for the user. However, the calling rate is higher than conventional PSTN. When the user is back home and needs to call someone, he/she usually uses PSTN to make a phone call because of the low calling rate. At the same time, to avoid missing any incoming call from the mobile phone, the user has to carry the mobile phone at any time. It is very inconvenient for the user.

Therefore, the scope of the invention is to provide a mobile communication apparatus to solve the aforesaid problems.

### SUMMARY OF THE INVENTION

A scope of the invention is to provide a mobile communication apparatus capable of selectively communicating via wireless network or PSTN.

According to an embodiment of the invention, the mobile communication apparatus selectively communicates with an access point (AP). The AP has a service area. At least one communication channel communicates with the AP and is used for transmitting signals. The mobile communication apparatus comprises a first communication module and a second communication module. The first communication module transmits signals in a first communication protocol. When the mobile communication apparatus moves into the service area of the AP, the second communication module communicates with the AP in a second communication protocol, such that the mobile communication apparatus is capable of selectively transmitting signals by the first communication module, or by the second communication module via the at least one communication channel.

In this embodiment, the at least one communication channel transmits signals via PSTN, and the first communication protocol is GSM, WCDMA, CDMA, PHS, or the like.

Therefore, according to the invention, the mobile communication apparatus can transmit signals by the first communication module in the first communication protocol. At the same time, when moving into the service area of the AP, the mobile communication apparatus can transmit signals by the second communication module via the at least one communication channel. In other words, when the user is back home, he/she still can use the mobile communication apparatus to call someone via conventional PSTN. It is very convenient and helps save money for the user.

The advantage and spirit of the invention may be understood by the following recitations together with the appended drawings.

### BRIEF DESCRIPTION OF THE APPENDED DRAWINGS

FIG. 1 is a functional block diagram illustrating a mobile communication apparatus according to a first embodiment of the invention.

FIG. 2 is a schematic diagram illustrating the mobile communication apparatus shown in FIG. 1 outside a service area of an AP.

FIG. 3 is a schematic diagram illustrating the mobile communication apparatus shown in FIG. 1 inside the service area of the AP.

### DETAILED DESCRIPTION OF THE INVENTION

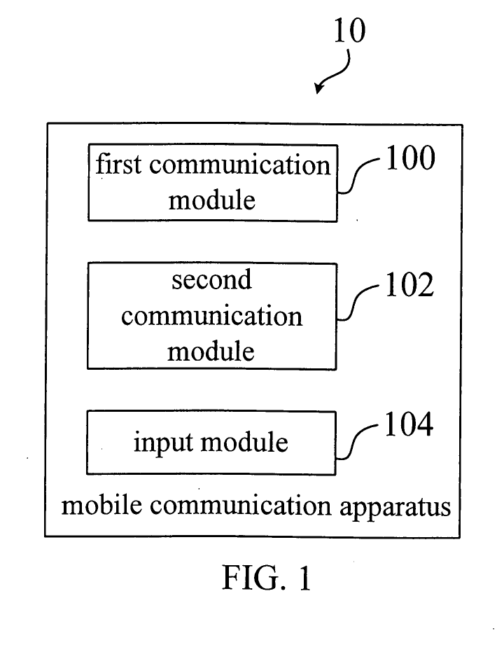

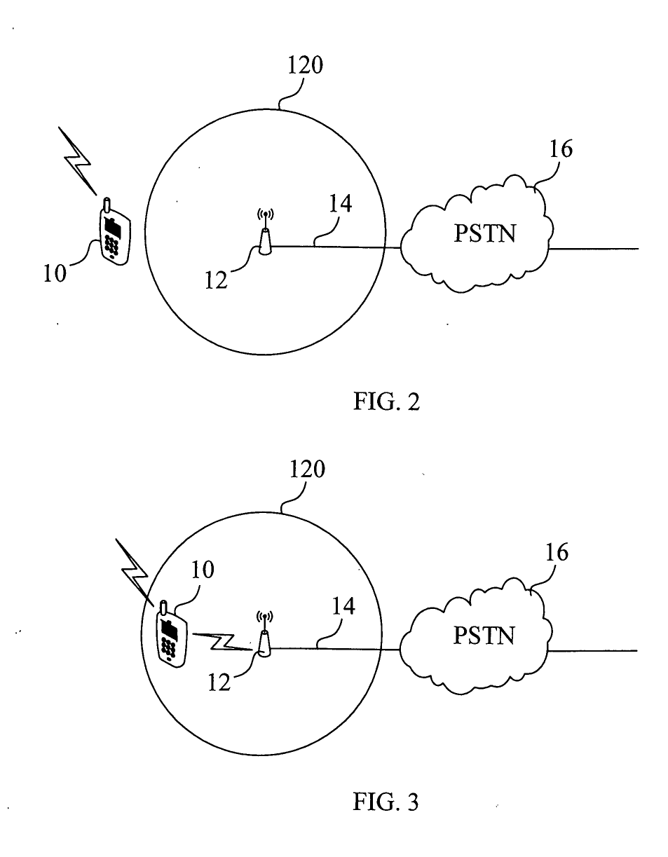

Please refer to FIG. 1 to FIG. 3. FIG. 1 is a functional block diagram illustrating a mobile communication apparatus 10 according to a first embodiment of the invention. FIG. 2 is a schematic diagram illustrating the mobile communication apparatus 10 shown in FIG. 1 outside a service area 120 of an AP 12. FIG. 3 is a schematic diagram illustrating the mobile communication apparatus 10 shown in FIG. 1 inside the service area 120 of the AP 12.

The mobile communication apparatus 10 selectively communicates with an access point (AP) 12. The AP 12 has a service area 120. At least one communication channel 14 communicates with the AP 12 and is used for transmitting signals. The communication channel 14 transmits signals via a public switched telephone network (PSTN) 16, as shown in FIG. 2. The mobile communication apparatus 10 comprises a first communication module 100 and a second communication module 102, as shown in FIG. 1. The first communication module 100 transmits signals in a first communication protocol. In this embodiment, the first communication protocol is GSM, WCDMA, CDMA, PHS, or the like. For example, if the first communication protocol is GSM, the mobile communication apparatus 10 is connected to wireless network in GSM for communication. As shown in FIG. 2, when the mobile communication apparatus 10 is outside the service area 120 of the AP 12, the mobile communication apparatus 10 only can be connected to wireless network in the first communication protocol for communication.

As shown in FIG. 3, when the mobile communication apparatus 10 moves into the service area 120 of the AP 12, the second communication module 102 communicates with the AP 12 in a second communication protocol, such that the mobile communication apparatus 10 is capable of transmitting signals by the second communication module 102 via the at least one communication channel 14. In this embodiment, the AP 12 can be a Bluetooth access point, and the second communication protocol can be a Bluetooth protocol. In another embodiment, the AP 12 can be a WiFi access point, and the second communication protocol can be a WiFi protocol. Accordingly, the mobile communication apparatus 10 is capable of selectively transmitting signals by the first communication module 100, or by the second communication module 102 via the at least one communication channel 14.

In other words, when the mobile communication apparatus 10 moves into the service area 120 of the AP 12, the mobile communication apparatus 10 not only can be connected to wireless network in the first communication protocol for communication but also can communicate with the AP 12 in the second communication protocol. That is to say, the mobile communication apparatus 10 also can be used to make a phone call via PSTN.

In the aforesaid embodiment, the mobile communication apparatus 10 further comprises an input module 104 for setting communication mode. That is to say, when the mobile communication apparatus 10 moves into the service area 120 of the AP 12, the user can use the input module 104 to set the priority of wireless network and PSTN for the mobile communication apparatus 10.

In another embodiment, the AP 12 also can be disposed in a charger associated with the mobile communication apparatus 10.

Compared to prior art, the mobile communication apparatus of the invention can be used to make a phone call via wireless network. At the same time, when moving into the service area of the AP, the mobile communication apparatus also can be used to make a phone call via PSTN. In other words, when the user is back home, he/she still can use the mobile communication apparatus to call someone via conventional PSTN instead of the telephone. It is very convenient for the user and helps the user economically make a call.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A mobile communication apparatus selectively communicating with an access point, the access point having a service area, at least one communication channel communicating with the access point and being used for transmitting signals, the mobile communication apparatus comprising:
a first communication module transmitting signals in a first communication protocol; and
a second communication module;
wherein when the mobile communication apparatus moves into the service area of the access point, the second communication module communicates with the access point in a second communication protocol, such that the mobile communication apparatus is capable of selectively transmitting signals by the first communication module, or by the second communication module via the at least one communication channel.

2. The mobile communication apparatus of claim 1, wherein the access point is a Bluetooth access point, and the second communication protocol is a Bluetooth protocol.

3. The mobile communication apparatus of claim 1, wherein the access point is a WiFi access point, and the second communication protocol is a WiFi protocol.

4. The mobile communication apparatus of claim 1, wherein the access point is disposed in a charger associated with the mobile communication apparatus.

5. The mobile communication apparatus of claim 1, wherein the at least one communication channel transmits signals via a public switched telephone network.

6. The mobile communication apparatus of claim 1, wherein the first communication protocol is one selected from the group consisting of GSM, WCDMA, CDMA, and PHS.

7. The mobile communication apparatus of claim 1, further comprising an input module for setting communication mode.
